(19) United States
(12) Patent Application Publication
(10) Pub. No.: US 2026/0139738 A1
(43) Pub. Date: May 21, 2026

(54) PARKING LOCK DEVICE

(71) Applicants: TOYOTA JIDOSHA KABUSHIKI KAISHA, Toyota-shi (JP); AISIN CORPORATION, Kariya (JP)

(72) Inventors: Taiki OWARI, Kariya-shi (JP); Yasukuni OJIMA, Kariya-shi (JP)

(73) Assignees: TOYOTA JIDOSHA KABUSHIKI KAISHA, Toyota-shi (JP); AISIN CORPORATION, Kariya (JP)

(21) Appl. No.: 19/368,961

(22) Filed: Oct. 24, 2025

(30) Foreign Application Priority Data
Nov. 20, 2024 (JP) 2024-202378

(51) Int. Cl. F16H 63/34

(52) U.S. Cl. CPC F16H 63/3433

(57) ABSTRACT

A parking lock device may include: a movable member moving between a first position and a second position according to a shift selector position; a parking gear; a parking pawl; and a restriction member. The pawl moves conjointly with the movable member such that the pawl is in a non-engaged position of not engaging with the gear when the movable member is in the first position, and is in an engaged position of engaging with the gear when the movable member is in the second position. The restriction member moves conjointly with the movable member such that the restriction member is positioned in a position of restricting the pawl from moving from the non-engaged position to the engaged position when the movable member is in the first position, and the restriction member retreats from the restriction position when the movable member moves from the first position to the second position.

### CROSS REFERENCE TO RELATED APPLICATIONS

This application claims priority from Japanese Patent Application No. 2024-202378 filed on Nov. 20, 2024. The entire content of the priority application is incorporated herein by reference.

### TECHNICAL FIELD

The art disclosed herein relates to a parking lock device.

### BACKGROUND ART

A parking lock device described in Japanese Patent Application Publication No. 2021-024499 has a parking gear and a parking pawl. The parking pawl shifts from an engaged position in which the pawl engages with the parking gear and a non-engaged position in which the pawl does not engage with the parking gear. When a parking position is selected with a gearshift lever of the vehicle, the parking pawl moves to the engaged position, at which the parking gear is prohibited from rotating. High acceleration may be applied on the parking pawl when there is an input from a road surface while the vehicle is traveling. If such application of acceleration causes the parking pawl to move toward the parking gear, the parking pawl would contact the rotating parking gear, resulting in generation of abnormal sound. The parking lock device of Japanese Patent Application Publication No. 2021-024499 detects unevenness of the road surface with a sensor while the vehicle is traveling, and when the vehicle detects the unevenness, the parking lock device actuates a solenoid valve actuator to regulate the movement of the parking pawl. Due to this, the parking lock device suppresses the parking pawl from contacting the parking gear while the vehicle is traveling.

### SUMMARY

In the technique of Japanese Patent Application Publication No. 2021-024499, if the unevenness of the road surface has suddenly worsened, the parking pawl may contact the parking gear within a time lag between the detection of the unevenness by the sensor and the activation of the solenoid valve actuator. The present teachings propose an art configured to more surely prevent a parking pawl from contacting a parking gear while a vehicle is traveling.

A parking lock device disclosed herein may comprise: a movable member configured to move between a first position and a second position according to a shift selector position; a parking gear; a parking pawl configured to move conjointly with the movable member such that the parking pawl is positioned in a non-engaged position when the movable member is in the first position, and is positioned in an engaged position when the movable member is in the second position, the non-engaged position being a position where the parking pawl does not engage with the parking gear, and the engaged position being a position where the parking pawl engages with the parking gear; and a restriction member configured to move conjointly with the movable member such that the restriction member is positioned in a restriction position when the movable member is in the first position, and the restriction member retreats from the restriction position when the movable member moves from the first position to the second position, the restriction position being a position where the restriction member restricts the parking pawl from moving from the non-engaged position to the engaged position.

In this parking lock device, when the movable member is in the first position, the parking pawl is positioned in the non-engaged position in which the parking pawl does not engage with the parking gear, and also the restriction member is positioned in the restriction position. Due to this, even if the parking pawl is subjected to acceleration while the vehicle is traveling (i.e., under a state where the parking pawl is in the non-engaged position), the parking pawl is restricted by the restriction member from moving from the non-engaged position to the engaged position. As such, because the restriction member is positioned in the restriction position while the vehicle is traveling (i.e., when the parking pawl is in the non-engaged position), the parking pawl can be surely prevented from making contact with the parking gear while the vehicle is traveling.

### BRIEF DESCRIPTION OF DRAWINGS

FIG. 1 is a perspective view of a parking lock device.

FIG. 2A is a view illustrating a layout of respective members when a parking position is selected.

FIG. 2B is a view illustrating a layout of respective members when the parking position is selected.

FIG. 3A is a view illustrating a layout of respective members when a non-parking position is selected.

FIG. 3B is a view illustrating a layout of respective members when the non-parking position is selected.

FIG. 4 is a partial perspective view of a parking lock device according to a modification.

### DETAILED DESCRIPTION

In one embodiment of the parking lock device disclosed herein, when the parking pawl moves from the non-engaged position toward the parking gear while the movable member is in the first position, the parking pawl may come into contact with the restriction member.

In one embodiment of the parking lock device disclosed herein, the restriction member may be secured to the movable member.

According to such configuration, the restriction member can move conjointly with the movable member.

In one embodiment of the parking lock device disclosed herein, the restriction member may be a rod configured to move conjointly with the movable member.

According to this configuration, the restriction member can move conjointly with the movable member.

In one embodiment, the parking lock device disclosed herein may further comprise: a spring biasing the parking pawl toward the non-engaged position; and an actuator configured to move the movable member between the first position and the second position according to a shift selector position.

According to this configuration, since the spring biases the parking pawl toward the non-engaged position, the parking pawl is placed in the non-engaged position. Since the restriction member restricts the movement of the parking pawl toward the engaged position, a spring with a relatively small biasing force can be used. Also, if the movable member is to be moved from the first position to the second position, the actuator moves the movable member against the force of the spring. Because the spring with the relatively small biasing force can be used, the actuator can be used with a smaller output. Due to this, the parking lock device can be made smaller.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved parking lock devices, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value positions or indications of groups of entities are intended to disclose every possible intermediate value or intermediate entity for the purpose of original written disclosure, as well as for the purpose of restricting the claimed subject matter.

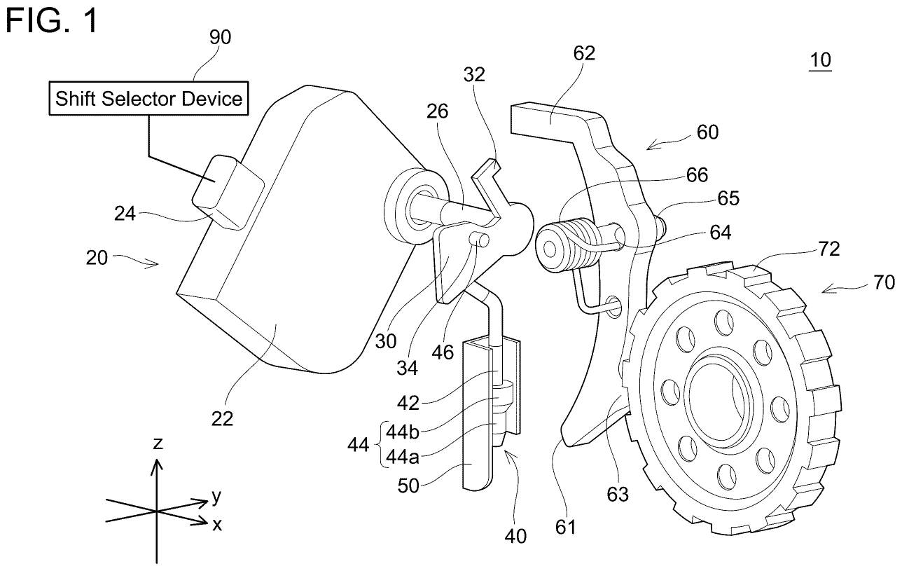

A parking lock device 10 of a first embodiment shown in FIG. 1 is mounted in a vehicle. The parking lock device 10 locks a drive axis of a vehicle (i.e., rotary axis which transmits power to wheels) according to a shift selector (gearshift) position. The parking lock device 10 comprises an actuator 20, a rotary member 30, a slide member 40, a guide member 50, a parking pawl 60, and a parking gear 70. Here, in FIG. 1, for easier illustration, a gap between the rotary member 30 and the slide member 40 and the parking pawl 60 is illustrated wider than the actual size. As will be described below, in actuality, the parking pawl 60 is disposed at a position at or near the rotary member 30 and the slide member 40.

The actuator 20 comprises a body 22, a connector 24, and an output shaft 26. The body 22 is secured on a housing of the vehicle. The connector 24 is disposed on the top surface of the body 22. The connector 24 has a shift selector device 90 of the vehicle electrically connected thereto. The shift selector device 90 is for example a gearshift lever or a gearshift switch, and is a device configured for a user to change the shift selector position. The shift selector device 90 inputs a signal indicative of the selected shift selector position to the actuator 20. The output shaft 26 protrudes from a side surface of the body 22. The actuator 20 rotates the output shaft 26 within a predetermined angular range according to whether a parking position is selected or a position other than the parking position (hereafter, non-parking position) is selected. Hereafter, an up-down direction will be denoted a z direction, a direction which is parallel to the center axis of the output shaft 26 in a horizontal plane will be denoted an x direction, and a direction which is perpendicular to the x direction in the horizontal plane will be denoted a y direction.

The rotary member 30 is secured to the output shaft 26 of the actuator 20. The rotary member 30 rotates about the x axis together with the output shaft 26. The rotary member 30 has a through hole 34 extending through the rotary member 30 in the x direction. The rotary member 30 has a protrusion 32 protruding upward. The tip of the protrusion 32 bends in an L shape.

The slide member 40 has a shaft portion 42 extending long in the z direction and a cam portion 44 secured to the lower end of the shaft portion 42. The cam portion 44 comprises a smaller-diameter portion 44a and a large-diameter portion 44b. The diameter of the large-diameter portion 44b is greater than the diameter of the smaller-diameter portion 44a. The large-diameter portion 44b is disposed above the smaller-diameter portion 44a. Between the smaller-diameter portion 44a and the large-diameter portion 44b, the diameter of the cam portion 44 increases gradually from the smaller-diameter portion 44a to the large-diameter portion 44b. An upper end 46 of the shaft portion 42 bends so as to be parallel to the x direction, and extends through the through hole 34 of the rotary member 30. Thus, the slide member 40 is configured to swing about the upper end 46 relative to the rotary member 30. The guide member 50 is disposed surrounding the slide member 40. The guide member 50 is secured on the housing of the vehicle. The guide member 50 restricts movement of the slide member 40 in the x direction and y direction, and permits movement of the slide member 40 in the z direction. Accordingly, when the rotary member 30 rotates, the slide member 40 slides upward and downward.

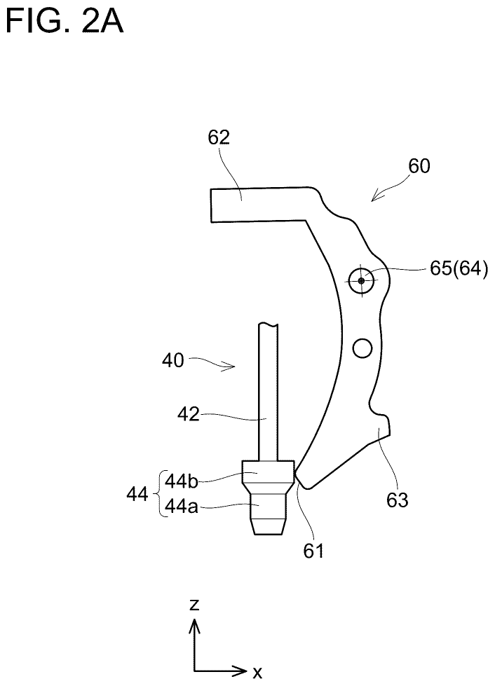

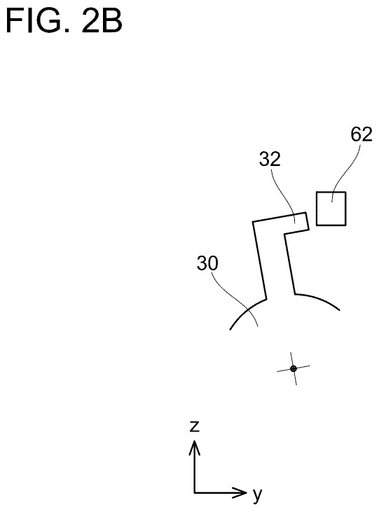

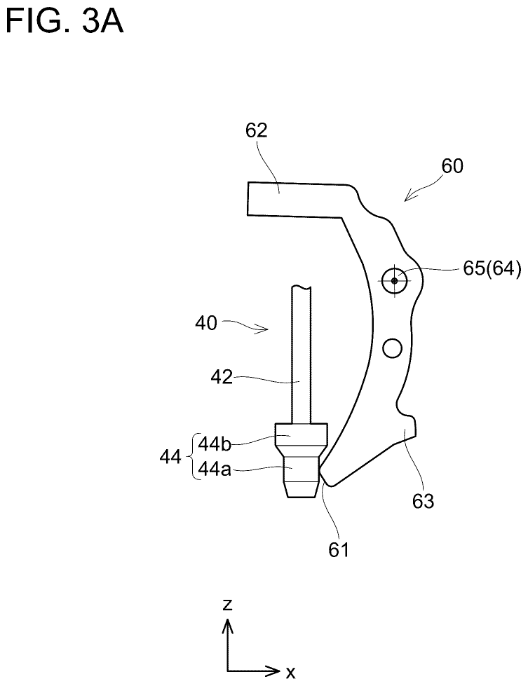

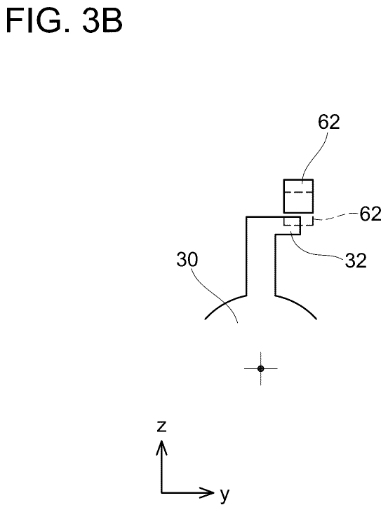

The parking pawl 60 has a shape long in the z direction. The parking pawl 60 is disposed next to the rotary member 30 and the slide member 40 in the x direction. That is, the rotary member 30 and the slide member 40 are disposed between the parking pawl 60 and the actuator 20. As illustrated in FIGS. 2A and 3A, the parking pawl 60 is disposed near the slide member 40 and the rotary member 30 such that a contact point 61 located on the lower end of the parking pawl 60 contacts the side surface of the cam portion 44. The parking pawl 60 has a side surface opposite from the slide member 40 provided with a projection 63 protruding in the x direction. As illustrated in FIG. 1, the parking pawl 60 has its upper end provided with a protrusion 62 protruding toward the actuator 20 along the x direction. The parking pawl 60 has a through hole 64 extending through the parking pawl 60 along the y direction. A shaft 65 extends through the through hole 64. The shaft 65 is secured to the housing of the vehicle. The parking pawl 60 is configured to swing about the y axis with the shaft 65 as its center. The shaft 65 is provided with a torsion spring 66. The torsion spring 66 exerts torque on the parking pawl 60 in a direction along which the contact point 61 approaches the cam portion 44 of the slide member 40. As illustrated in FIGS. 2A and 3A, when the cam portion 44 of the slide member 40 moves upward and downward, the position of the parking pawl 60 contacting the cam portion 44 changes between the smaller-diameter portion 44a and the large-diameter portion 44b. Due to this, by the slide member 40 moving upward and downward, the parking pawl 60 moves (swings) between the position of FIG. 2A and the position of FIG. 3A.

The parking gear 70 has a circular disk shape, and is secured on the drive axis of the vehicle extending along the y direction. Accordingly, the parking gear 70 rotates about the y axis together with the drive axis. The parking gear 70 is disposed at a position next to the parking pawl 60 in the x direction. That is, the parking pawl 60 is disposed between the slide member 40 and the parking gear 70. The parking gear 70 has an outer circumferential surface provided with a plurality of gear teeth 72. When the parking pawl 60 is positioned in the position of FIG. 2A, the projection 63 of the parking pawl 60 engages with the gear teeth 72 of the parking gear 70, by which the parking gear 70 becomes unable to rotate. When the parking pawl 60 is positioned in the position of FIG. 3A, the projection 63 of the parking pawl 60 is detached from the parking gear 70 (becomes non-contact), by which the parking gear 70 becomes able to rotate. That is, FIG. 2A shows the parking pawl 60 in the engaged position, and FIG. 3A shows the parking pawl 60 in a non-engaged position.

Next, operation of the parking lock device 10 will be described. As described above, the actuator 20 rotates the output shaft 26 within a predetermined angular range depending on whether the parking position is selected by the shift selector device 90. The actuator 20 rotates the rotary member 30 by rotating the output shaft 26. The actuator 20 rotates the rotary member 30 between the position shown in FIG. 2B and the position shown in FIG. 3B. When the parking position is selected, the actuator 20 positions the rotary member 30 in the position of FIG. 2B, and when the non-parking position is selected, the actuator 20 positions the rotary member 30 in the position of FIG. 3B. Also, the slide member 40 connected to the rotary member 30 moves upward and downward, along with the movement of the rotary member 30, between the position shown in FIG. 2A and the position shown in FIG. 3A. When the parking position is selected (i.e., when the rotary member 30 is in the position of FIG. 2B), the slide member 40 is positioned in the position of FIG. 2A, and when the non-parking position is selected (i.e., when the rotary member 30 is in the position of FIG. 3B), the slide member 40 is positioned in the position of FIG. 3A. As such, the slide member 40 moves upward and downward according to the shift selector position. When the slide member 40 has moved upward from the position of FIG. 3A, the contact point 61 is pushed by the large-diameter portion 44b in the x direction as in FIG. 2A, by which the parking pawl 60 rotates and the projection 63 moves toward the parking gear 70. Then, the projection 63 engages with the gear teeth 72 of the parking gear 70, by which the parking gear 70 is prohibited from rotating. When the slide member 40 has moved downward from the position of FIG. 2A, the parking pawl 60 rotates such that the contact point 61 contacts the smaller-diameter portion 44a due to the biasing force of the torsion spring as in FIG. 3A, by which the projection 63 of the parking pawl 60 moves in a direction of separating away from the parking gear 70. Then, the projection 63 is detached from the parking gear 70, by which the rotation of the parking gear 70 is permitted. As such, the parking lock device 10 prohibits the rotation of the parking gear when the parking position is selected, and the parking lock device 10 permits the rotation of the parking gear when the non-parking position is selected.

The relative positions between the protrusion 62 of the parking pawl 60 and the protrusion 32 of the rotary member 30 change depending on the shift selector position. As illustrated in FIG. 2B and FIG. 3B, the protrusion 32 of the rotary member 30 moves in the y direction depending on the rotation of the rotary member 30. Further, as illustrated in FIG. 2B and FIG. 3B, the protrusion 62 of the parking pawl 60 moves in the z direction depending on the rotation of the parking pawl 60. As illustrated in FIG. 3B, when the non-parking position is selected, the protrusion 62 of the parking pawl 60 is located at a higher level, and the protrusion 32 of the rotary member 30 is located below the protrusion 62. The position of the protrusion 32 shown in FIG. 3B is a restriction position where the protrusion 32 restricts the protrusion 62 from moving downward. When the non-parking position is switched to the parking position, as illustrated in FIG. 2B, the protrusion 32 moves in the y direction, and retreats from the position below the protrusion 62 (i.e., restriction position), and the protrusion 62 comes to the lower side. When the parking position is switched to the non-parking position, as illustrated in FIG. 3B, the protrusion 62 moves upward, and the protrusion 32 moves in the y direction to enter below the protrusion 62 (i.e., restriction position). As such, when the shift selector position is changed, the protrusion 32 and the protrusion 62 move without interfering with each other.

Since the non-parking position has been selected while the vehicle is traveling, the respective members are in the positions shown in FIG. 3. Depending on unevenness of the road surface on which the vehicle is traveling, high acceleration may be applied on the parking pawl 60. If high acceleration is applied on the parking pawl 60 in a direction opposite from a biasing direction of the torsion spring 66, the parking pawl 60 rotates in the direction approaching the parking gear 70. If this causes the projection 63 of the parking pawl 60 to contact the rotating parking gear 70, problem(s) such as generation of abnormal sound and/or wear of the projection 63 and/or the parking gear 70 would occur. In the present embodiment, however, when the parking pawl 60 moves toward the parking gear 70 with the non-parking position selected (i.e., the state of FIG. 3B), the protrusion 62 comes into contact with the protrusion 32 of the rotary member 30. Due to this, the protrusion 62 cannot move to the position where the projection 63 engages with the parking gear 70 (i.e., position in broken lines of FIG. 3B). Due to this, the parking pawl 60 can be suppressed from contacting the parking gear 70 while the vehicle is traveling. Since the protrusion 32 is positioned in the position of FIG. 3B (i.e., restriction position) at all times when the non-parking position is selected, the parking pawl 60 can be surely prevented from contacting the parking gear 70.

Also, if there is no protrusion 32, the biasing force of the torsion spring 66 needs to be utilized to prevent the parking pawl 60 from contacting the parking gear 70. Contrary to this, in the present embodiment, due to the presence of the protrusion 32, the biasing force of the torsion spring 66 may be weak. Due to this, the actuator 20 can rotate the output shaft 26 at smaller torque. Due to this, an actuator with smaller output torque can be used as the actuator 20, by which the size of the actuator 20 can be made smaller. Due to this, the size of the parking lock device 10 can be made smaller.

The rotary member 30 and the slide member 40 in the present embodiment are an example of a movable member configured to move between a first position and a second position according to a shift selector position. The positions of the rotary member 30 and the slide member 40 in FIG. 3 are an example for the first position. The positions of the rotary member 30 and the slide member 40 in FIG. 2 are an example for the second position.

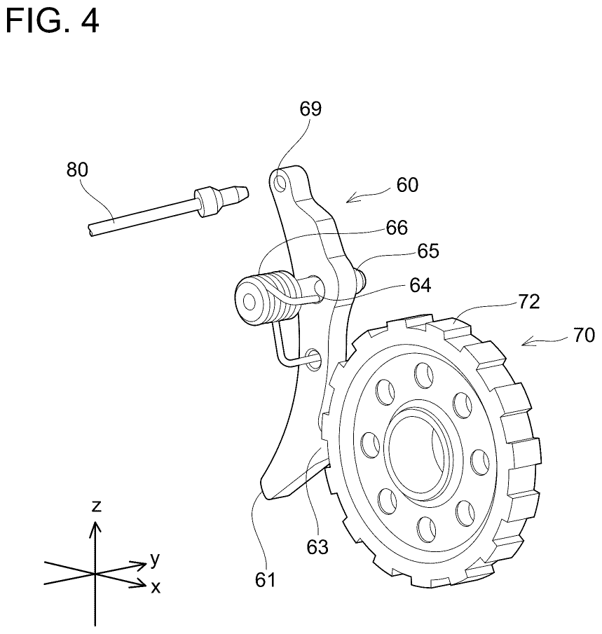

In the above embodiment, the protrusion 32 integral with the rotary member 30 works as the restriction member configured to suppress the parking pawl 60 from contacting the parking gear 70. However, a restriction rod 80 shown in FIG. 4 may be provided as the restriction member. The restriction rod 80 is provided as a separate member from the rotary member 30. The restriction rod 80 extends long in the y direction, and moves along the y direction according to the rotation of the rotary member 30. In FIG. 4, a hole 69 extending along the y direction is formed in the parking pawl 60. When the parking position is selected, the restriction rod 80 is positioned in a position not in contact with (detached from) the parking pawl 60. When the non-parking position is selected, the restriction rod 80 is inserted in the hole 69, with the parking pawl 60 in the non-engaged position. This can suppress the parking pawl 60 from moving from the non-engaged position to the engaged position while the vehicle is traveling.

What is claimed is:

1. A parking lock device comprising:
a movable member configured to move between a first position and a second position according to a shift selector position;
a parking gear;
a parking pawl configured to move conjointly with the movable member such that the parking pawl is positioned in a non-engaged position when the movable member is in the first position, and is positioned in an engaged position when the movable member is in the second position, the non-engaged position being a position where the parking pawl does not engage with the parking gear, and the engaged position being a position where the parking pawl engages with the parking gear; and
a restriction member configured to move conjointly with the movable member such that the restriction member is positioned in a restriction position when the movable member is in the first position, and the restriction member retreats from the restriction position when the movable member moves from the first position to the second position, the restriction position being a position where the restriction member restricts the parking pawl from moving from the non-engaged position to the engaged position.

2. The parking lock device of claim 1, wherein, when the parking pawl moves from the non-engaged position toward the parking gear while the movable member is in the first position, the parking pawl comes into contact with the restriction member.

3. The parking lock device of claim 1, wherein the restriction member is secured to the movable member.

4. The parking lock device of claim 1, wherein the restriction member is a rod configured to move conjointly with the movable member.

5. The parking lock device of claim 1, further comprising:
a spring biasing the parking pawl toward the non-engaged position; and
an actuator configured to move the movable member between the first position and the second position according to a shift selector position.
